(19) United States
(12) Patent Application Publication
(10) Pub. No.: US 2004/0128303 A1
(43) Pub. Date: Jul. 1, 2004

(54) Outsourcing management system and method

(76) Inventor: Juei-Mei Wang, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/680,318

(22) Filed: Oct. 6, 2003

(30) Foreign Application Priority Data
Dec. 27, 2002 (TW) 91137595

(51) Int. Cl. G06F 17/00

(52) U.S. Cl. 707/101

(57) ABSTRACT

An outsourcing management system includes a database server (1) comprising a database for storing information and statements, an application server (2) linked to the database server for integrating information on suppliers and outsourcing goods to select suitable suppliers whose performance records are satisfactory, generating outsourcing transaction accounting entries, and for managing outsourcing transaction variations as well, and a plurality of client computers (4) which are located at different places of an organization for searching performance information of various suppliers. The application server includes a supplier performance information analysis module (21), an outsourcing transaction accounting entry maintenance module (22), an outsourcing transaction variation information maintenance module (23) and an outsourcing account maintenance module (24). An outsourcing management method is also disclosed.

### BACKGROUND OF THE INVENTION

1. Field of the Invention

The present invention relates to outsourcing management systems and methods, especially to an outsourcing management system and method through which purchasing companies can select suitable suppliers according to performance records of various suppliers.

2. Background of the Invention

Procurement efficiency is vital for many companies, especially mass-production manufacturers. Conventional procurement systems that are separated from inventory management, production and accounting systems can retard the efficiency of a company's supply chain. Nowadays, more and more corporations are integrating procurement operations with production planning, inventory management, and accounting and auditing. Such integration is intended to improve production efficiency and simplify procurement management.

A general outsourcing management system can gather information on procurement, inventory and accounting, and integrate data on suppliers and outsourcing goods to select optimal suppliers. The art of computerized outsourcing management is disclosed in patents such as U.S. Pat. No. 6,301,574 issued on Oct. 9, 2001 and entitled System for Providing Business Information. This patent discloses a system for checking purchased material against corresponding standards stored in a database when selecting suppliers. However, disadvantages of the system include the fact that no performance records are provided for various suppliers. This can result in the purchase of bad quality goods, and may delay production planning.

There is presently no automated system or method which can not only integrate information on procurement, inventory and accounting, but also record performance information on various suppliers according to outsourcing transaction information and generate outsourcing transaction accounting entries used in managing outsourcing accounts.

### SUMMARY OF THE INVENTION

A main objective of the present invention is to provide an outsourcing management system and method, whereby a purchasing department can select suitable suppliers according to performance records of various suppliers.

Another objective of the present invention is to provide an outsourcing management system and method which can create outsourcing transaction accounting entries, and carry forward outsourcing accounts thereof to general ledgers.

To accomplish the above objectives, an outsourcing management system in accordance with a preferred embodiment of the present invention comprises an application server, a database server, and a plurality of client computers linking to the application server through a network, wherein the application server comprises: a supplier performance information analysis module for analyzing performance records of various suppliers to determine suitable suppliers; an outsourcing transaction accounting entry maintenance module for creating and maintaining outsourcing transaction accounting entries; an outsourcing account maintenance module for computing outsourcing accounts, and for carrying forward the outsourcing accounts to general legers; and an outsourcing transaction variation information maintenance module for dealing with variations occurring in outsourcing transactions.

Further, the present invention provides a preferred outsourcing management method comprising the steps of: (a) receiving outsourcing goods information and supplier information, and determining whether a performance record for the supplier has been set up; (b) obtaining the performance record for the supplier and historical transaction records of trading with the supplier if the performance record for the supplier has been set up; (c) determining whether the performance record is satisfactory; (d) checking the quality of delivered goods if the performance record is satisfactory, and accepting the delivered goods if the quality of the delivered goods is satisfactory; (e) creating outsourcing transaction accounting entries and computing outsourcing accounts thereof; and (f) carrying forward the outsourcing accounts to general ledgers, and outputting accounting statements.

Other objects, advantages and novel features of the present invention will be drawn from the following detailed description of the preferred embodiment and preferred methods of the present invention with the attached drawings, in which:

### BRIEF DESCRIPTION OF THE DRAWINGS

FIG. 1 is a schematic diagram of hardware configuration of an outsourcing management system in accordance with the preferred embodiment of the present invention;

FIG. 2 is a block diagram of main information used in the outsourcing management system of FIG. 1;

FIG. 3 is a schematic diagram of main function units of an application server of the outsourcing management system of FIG. 1;

FIG. 4 is a flowchart of a preferred method for implementing the outsourcing management system of FIG. 1; and

FIG. 5 is a flowchart of dealing with outsourcing transaction variations when the outsourcing management system of FIG. 1 is used.

### DETAILED DESCRIPTION OF THE INVENTION

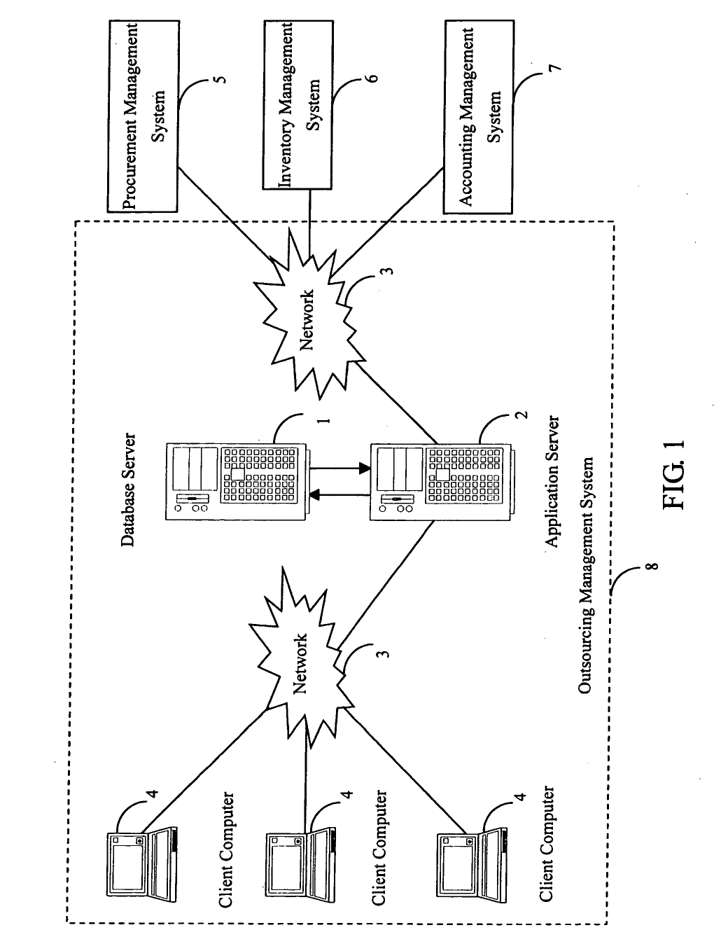

FIG. 1 is a schematic diagram of hardware configuration of an outsourcing management system in accordance with the preferred embodiment of the present invention. The outsourcing management system 8 comprises a database server 1, an application server 2, a network 3, and a plurality of client computers 4. The database server 1 comprises a database for storing information and statements. The application server 2 integrates information on suppliers and outsourcing goods to select suitable suppliers whose performance records are satisfactory, generates outsourcing transaction accounting entries, and manages outsourcing transaction variations as well. The client computers 4 are located at different places in an organization, whereby various users can search performance information on various suppliers. The outsourcing management system 8 is connected with a procurement management system 5, an inventory management system 6, and an accounting management system 7 through the network 3.

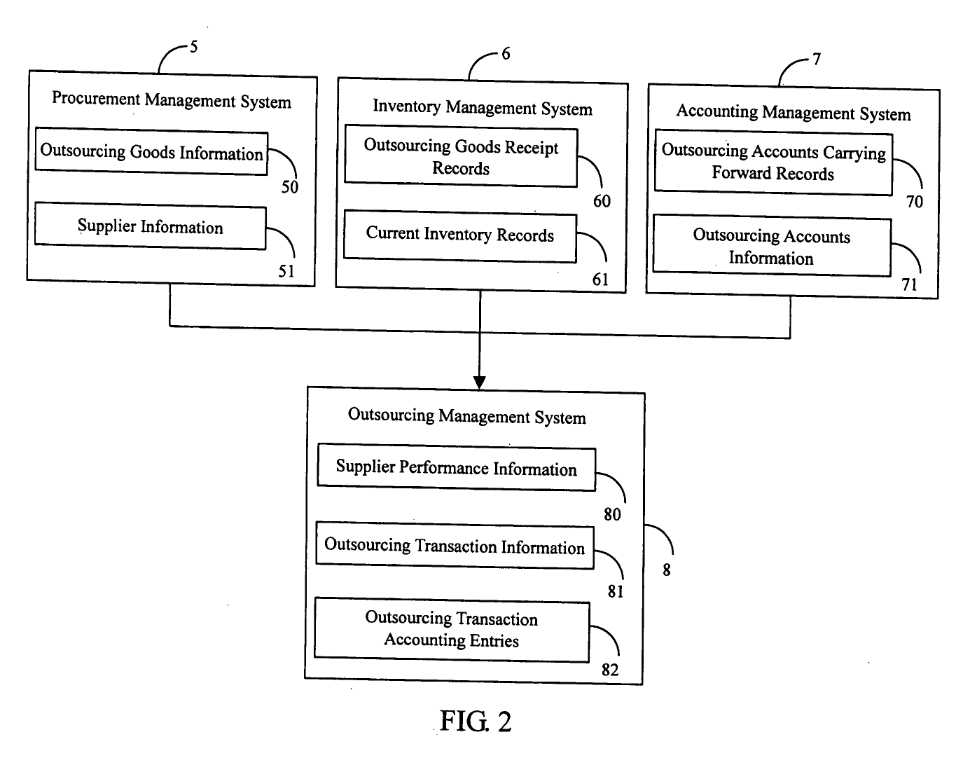

FIG. 2 is a block diagram of main information used in the outsourcing management system 8. The outsourcing management system 8 can single out suitable suppliers to engage in efficacious outsourcing transactions by integrating information from the procurement management system 5, the inventory management system 6 and the accounting management system 7. The procurement management system 5 provides outsourcing goods information 50 and supplier information 51. The inventory management system 6 provides outsourcing goods receipt records 60 and current inventory records 61. The current inventory records 61, together with the outsourcing goods information 50, are used to determine a purchasing amount of each outsourcing transaction. The outsourcing goods receipt records 60, which comprise historical information on goods delivered by the supplier, can help to set up a performance record for the supplier. The accounting management system 7 provides outsourcing accounts carrying forward records 70 and outsourcing accounts information 71 to illustrate accounting balances of outsourcing transactions. The outsourcing management system 8 provides supplier performance information 80, outsourcing transaction information 81, and outsourcing transaction accounting entries 82. The supplier performance information 80 comprises performance records of various suppliers used for determining suitable suppliers. Information on a performance record comprises historical records about the quality of goods delivered by the supplier, a frequency of delayed deliveries, after delivery services, and so on. The outsourcing transaction information 81 comprises historical outsourcing transaction records of various suppliers.

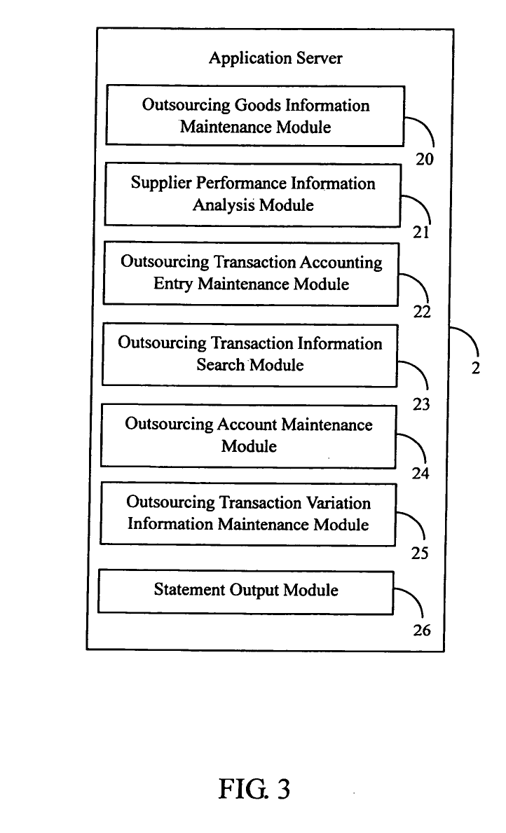

FIG. 3 is a schematic diagram of main function units of the application server 2. The application server 2 comprises an outsourcing goods information maintenance module 20, a supplier performance information analysis module 21, an outsourcing transaction accounting entry maintenance module 22, an outsourcing transaction information search module 23, an outsourcing account maintenance module 24, an outsourcing transaction variation information maintenance module 25, and a statement output module 26.

The outsourcing goods information maintenance module 20 maintains information on outsourcing goods obtained from the outsourcing goods information 50 of the procurement management system 5. The supplier performance information analysis module 21 analyzes performance records of various suppliers obtained from the supplier performance information 80 to determine suitable suppliers. Furthermore, the supplier performance information analysis module 21 creates a new performance record for a supplier when there is no performance record for that supplier in the supplier performance information 80. The outsourcing transaction accounting entry maintenance module 22 is for creating and maintaining outsourcing transaction accounting entries. Each outsourcing transaction accounting entry comprises a plurality of outsourcing accounts that can be computed and carried forward to general ledgers of the accounting management system 7. The outsourcing transaction information search module 23 is for searching historical outsourcing transaction records. The outsourcing account maintenance module 24 is used for computing outsourcing accounts and carrying forward the outsourcing accounts to general ledgers. The outsourcing transaction variation information maintenance module 25 deals with variations occurring in outsourcing transactions. The statement output module 26 generates relevant statements, such as accounting statements and statements on suppliers and outsourcing goods.

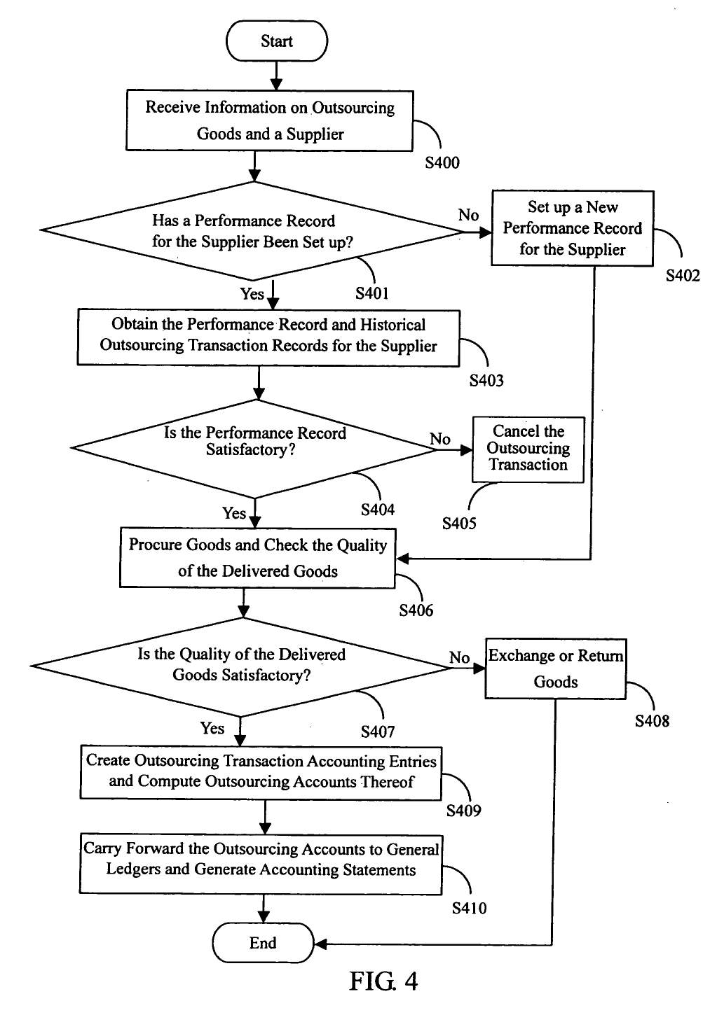

FIG. 4 is a flowchart of a preferred method for implementing the outsourcing management system 8. In step S400, the application server 2 receives outsourcing goods information from the outsourcing goods information 50 and information on a relevant supplier from the supplier information 51. In step S401, the application server 2 searches the supplier performance information 80 through the supplier performance information analysis module 21 to determine whether a performance record for the supplier has been set up.

If there is no performance record for the supplier in the supplier performance information 80, in step S402, the supplier performance information analysis module 21 creates a new performance record for the supplier, and the procedure proceeds directly to step S406 described below.

If the performance record for the supplier has been set up, in step S403, the application server 2 obtains the performance record from the supplier performance information 80, and searches historical outsourcing transaction records of trading with the supplier in the outsourcing transaction information 81 through the outsourcing transaction information search module 23.

In step S404, the supplier performance information analysis module 21 analyzes the performance record and historical outsourcing transaction records to determine whether the performance record for the supplier is satisfactory. If the performance record is not satisfactory, in step S405, the application server 2 notifies one client computer 4 in a purchasing department of the organization to cancel the outsourcing transaction. If the performance record is satisfactory, in step S406, the application server 2 notifies the purchasing department to procure goods from the supplier, and to check the quality of the delivered goods upon their arrival at the organization's premises.

In step S407, the application server 2 receives information on whether the quality of the delivered goods is satisfactory. If the quality of the delivered goods is not satisfactory, in step S408, the application server 2 notifies the purchasing department to stop the outsourcing transaction. The application server 2 also requires the supplier to exchange the delivered goods, or directs return of the delivered goods to the supplier. If the quality of the delivered goods is satisfactory, in step S409, the outsourcing transaction accounting entry maintenance module 22 creates outsourcing transaction accounting entries, and the outsourcing account maintenance module 24 computes outsourcing accounts thereof. In step S410, the outsourcing account maintenance module 24 carries forward the outsourcing accounts to general ledgers, generates accounting statements to be stored in the database, and generates outsourcing accounts carrying forward records 70 to be stored in the accounting management system 7.

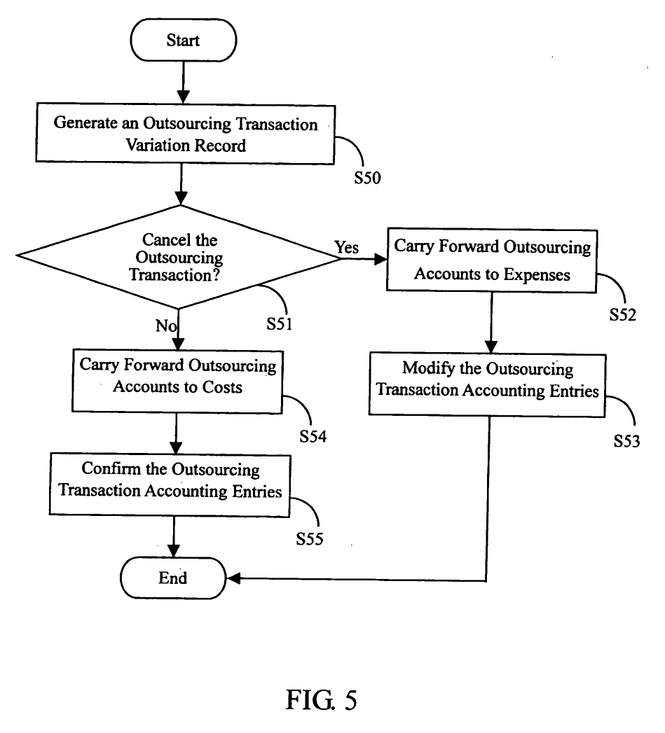

FIG. 5 is a flowchart of dealing with outsourcing transaction variations when the outsourcing management system 8 is implemented. In step S50, an outsourcing transaction variation may occur, for example, when a supplier cannot deliver goods in time. When such variation occurs, the outsourcing transaction variation information maintenance module 25 generates an outsourcing transaction variation record. In step S51, the application server 2 receives information from the purchasing department on whether it is necessary to cancel the outsourcing transaction. If it is not necessary to cancel the outsourcing transaction, in step S54, the outsourcing account maintenance module 24 carries forward outsourcing accounts to costs in the general ledgers. In step S55, the application server 2 notifies the accounting management system 7 to confirm the outsourcing transaction accounting entries. If it is necessary to cancel the outsourcing transaction, in step S52, the application server 2 informs the purchasing department to stop the outsourcing transaction, and the outsourcing account maintenance module 24 carries forward the outsourcing accounts to expenses in the general ledgers. In step S53, the application server 2 notifies the accounting management system 7 to modify the relevant outsourcing transaction accounting entries.

Although the present invention has been specifically described on the basis of a preferred embodiment and preferred methods, the invention is not to be construed as being limited thereto. Various changes or modifications may be made to said embodiment and methods without departing from the scope and spirit of the invention.

What is claimed is:

1. An outsourcing management system for selecting suitable suppliers according to performance records of suppliers, the outsourcing management system comprising an application server, a database server, and a plurality of client computers linked to the application server through a network, wherein the application server comprises:
a supplier performance information analysis module for analyzing performance records of various suppliers to determine suitable suppliers;
an outsourcing transaction accounting entry maintenance module for creating and maintaining outsourcing transaction accounting entries;
an outsourcing account maintenance module for computing outsourcing accounts, and carrying forward the outsourcing accounts to general ledgers; and
an outsourcing transaction variation information maintenance module for dealing with variations occurring in outsourcing transactions.

2. The system according to claim 1, wherein the application server further comprises an outsourcing goods information maintenance module for maintaining information on outsourcing goods.

3. The system according to claim 1, wherein the application server further comprises an outsourcing transaction information search module for searching historical outsourcing transaction records.

4. The system according to claim 1, wherein the application server further comprises a statement output module for generating accounting statements and statements on suppliers and outsourcing goods.

5. A computer-enabled outsourcing management method comprising the steps of:
(a) receiving outsourcing goods information and supplier information, and determining whether a performance record for a supplier has been set up;
(b) obtaining the performance record for the supplier and historical transaction records of trading with the supplier if the performance record for the supplier has been set up;
(c) determining whether the performance record for the supplier is satisfactory;
(d) checking the quality of delivered goods if the performance record is satisfactory, and accepting the delivered goods if the quality of the delivered goods is satisfactory;
(e) creating outsourcing transaction accounting entries and computing outsourcing accounts thereof; and
(f) carrying forward the outsourcing accounts to general ledgers, and outputting accounting statements.

6. The method according to claim 5, wherein step (b) further comprises the step of creating a new performance record for the supplier if there is no performance record for the supplier.

7. The method according to claim 5, wherein step (d) further comprises the step of informing a purchasing department to cancel a scheduled outsourcing transaction if the performance record is not satisfactory.

8. The method according to claim 5, wherein step (d) further comprises the step of informing the supplier to exchange the delivered goods or returning the delivered goods to the supplier, if the quality of the delivered goods is not satisfactory.

9. A combined system for outsourcing, comprising:
a procurement management system including outsourcing good information and supplier information;
an inventory management system including outsourcing goods receipt records and current inventory records; and
an accounting management system including outsourcing accounting carrying forward records and outsourcing accounts information; wherein
said procurement management system, said inventory management system and said accounting management system are all linked to an outsourcing management system including supplier performance information, outsourcing transaction information and outsourcing transaction accounting entries.
